(19) United States
(12) Patent Application Publication
(10) Pub. No.: US 2014/0258913 A1
(43) Pub. Date: Sep. 11, 2014

(54) IMAGE PROCESSING SYSTEM, IMAGE PROCESSING CONTROL METHOD, AND RECORDING MEDIUM STORING IMAGE PROCESSING CONTROL PROGRAM

(71) Applicants: Tomoki Shibukawa, Kanagawa (JP); Hajime Kubota, Kanagawa (JP); Tadashi Nagata, Kanagawa (JP)

(72) Inventors: Tomoki Shibukawa, Kanagawa (JP); Hajime Kubota, Kanagawa (JP); Tadashi Nagata, Kanagawa (JP)

(73) Assignee: RICOH COMPANY., LTD., Tokyo (JP)

(21) Appl. No.: 14/197,406

(22) Filed: Mar. 5, 2014

(30) Foreign Application Priority Data
Mar. 11, 2013 (JP) 2013-047993

(51) Int. Cl. G06F 3/0484

(52) U.S. Cl. CPC G06F 3/0484
USPC 715/778

(57) ABSTRACT

An image processing system that includes an image processing apparatus and an information processing device that is separate from the image processing apparatus and controls operation of the image processing apparatus. The information processing device includes a display configured to display one of a standard screen that displays multiple setting items to be configured in operating the image processing apparatus and a simple screen that displays some of the multiple setting items displayed on the standard screen, an operational acceptance unit to accept an operation performed on a screen displayed on the display of the information processing device, and a display switcher configured to switch display on the display of the information processing device between the standard screen and the simple screen when the operation accepted by the operational acceptance unit indicates a predetermined operation regardless of coordinates of the operation performed on the screen.

### CROSS-REFERENCE TO RELATED APPLICATION

This patent application is based on and claims priority pursuant to 35 U.S.C. §119 to Japanese Patent Application No. 2013-047993, filed on Mar. 11, 2013 in the Japan Patent Office, the entire disclosure of which is hereby incorporated by reference herein.

### BACKGROUND

1. Technical Field

The present invention relates to an image processing system, image processing control method, and recording medium storing an image processing control program.

2. Background Art

With increased computerization of information, image processing apparatuses such as printers and facsimiles used for outputting the computerized information and scanners used for computerizing documents have become indispensable. In most cases, these image processing apparatuses are configured as multifunctional peripherals (MFPs) that can be used as printers, facsimiles, scanners, or copiers by implementing an image pickup function, image forming function, and communication function, etc.

On the other hand, mobile phones have also become highly functionalized, and mobile information processing apparatuses such as smart phones and tablet devices (hereinafter referred to as “mobile devices”) that have information processing functions approaching the sophistication of PCs have become popular. These mobile devices are generally configured with touch-screen panels that recognize gestures of the fingers or styluses at arbitrary positions on the screen (e.g., pinch out and pinch in), and it is possible to instruct the mobile devices to enlarge the display screen by pinch out and reduce the display screen by pinch in intuitively.

In image processing apparatuses that include a touch panel to accept the gestures described above, a technology that configures a home screen in accordance with operation history and displays the home screen has been proposed (e.g., JP-2011-170574-A).

### SUMMARY

An example embodiment of the present invention provides an image processing system that includes an image processing apparatus and an information processing device that is separate from the image processing apparatus and controls operation of the image processing apparatus. The information processing device includes a display configured to display one of a standard screen that displays multiple setting items to be configured in operating the image processing apparatus and a simple screen that displays some of the multiple setting items displayed on the standard screen, an operational acceptance unit to accept an operation performed on a screen displayed on the display of the information processing device, and a display switcher configured to switch display on the display of the information processing device between the standard screen and the simple screen when the operation accepted by the operational acceptance unit indicates a predetermined operation regardless of coordinates of the operation performed on the screen.

Another example embodiment of the present invention provides a method of using the information processing device as the operational unit of the image processing apparatus, and a non-transitory recording medium storing a program that causes a computer to implement the method of using the information processing device as the operational unit of the image processing apparatus.

### BRIEF DESCRIPTION OF THE DRAWINGS

A more complete appreciation of the disclosure and many of the attendant advantages thereof will be readily obtained as the same becomes better understood by reference to the following detailed description when considered in conjunction with the accompanying drawings.

FIG. 1 is a diagram illustrating a system as an embodiment of the present invention.

FIG. 2 is a block diagram illustrating a hardware configuration of an information processing apparatus as an embodiment of the present invention.

FIG. 3 is a block diagram illustrating a functional configuration of the image processing apparatus as an embodiment of the present invention.

FIG. 4 is a block diagram illustrating a functional configuration of a mobile device as an embodiment of the present invention.

FIG. 5 is a block diagram illustrating a functional configuration of a mobile controller as an embodiment of the present invention.

FIG. 6 is a diagram illustrating operation configuration information as an embodiment of the present invention.

FIG. 7 is a flowchart illustrating a process performed by a display switcher as an embodiment of the present invention.

FIG. 8 is a diagram illustrating a standard screen as an embodiment of the present invention,

FIG. 9 is a diagram illustrating a simple screen as an embodiment of the present invention

FIG. 10 is a diagram illustrating operation configuration information as another embodiment of the present invention.

FIG. 11 is a flowchart illustrating a process performed by the display switcher as another embodiment of the present invention.

### DETAILED DESCRIPTION

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

Operations on the screen displayed on the image processing apparatus include not only enlarging/reducing the screen but also switching from a standard screen that displays multiple settings to be configured in operating the image processing apparatus (e.g., color settings and magnification settings in copying) to a simple screen that displays only some of the multiple settings displayed on the standard screen. Usually, in operating the image processing apparatuses, it is necessary to locate the position of a button necessary to switch between the standard screen and the simple screen, and in some cases, it is difficult for a user who is not proficient at operating the image processing apparatus to perform the switching operation.

Consequently, it is desirable to have the screen that can be switched between the standard screen and the simple screen intuitively. However, even in the case of using the image processing apparatus that includes the touch panel that accepts gestures to input intuitively or using the mobile device having the touch panel for operating the image processing apparatus, the screen is not switched from the standard screen to the simple screen and vice versa intuitively.

In the following embodiment, an image processing system, image processing control method, and recording medium storing a image processing control program are provided, each of which is capable of switching the screen from the standard screen to the simple screen and vice versa.

In the following embodiment, a system in which the image processing apparatus is operated via a mobile device such as a smart phone and a tablet is taken as an example and described in detail with reference to the accompanying figures.

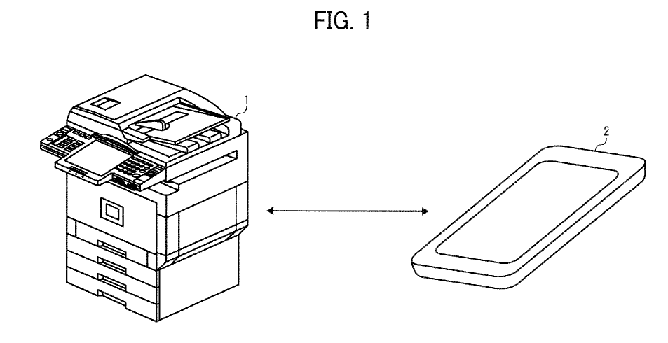

FIG. 1 is a diagram illustrating a system in this embodiment. As shown in FIG. 1, in the image processing system in this embodiment, an image processing apparatus 1 and a mobile device 2 are communicatively connected with each other.

The image processing apparatus 1 is, for example, a MFP that can be used as a printer, facsimile, scanner, or copier by implementing an image pickup function, image forming function, and communication function, etc. The mobile device 2 is a mobile information processing device such as a smart phone, tablet device, and personal digital assistant (PDA). In this embodiment, the mobile device 2 operates independently of the image processing apparatus 1 and functions as a control panel for operating the image processing apparatus 1 by wired/wireless communication with the image processing apparatus 1, using an application program provided by either the manufacturer of the image processing apparatus 1 or a third party.

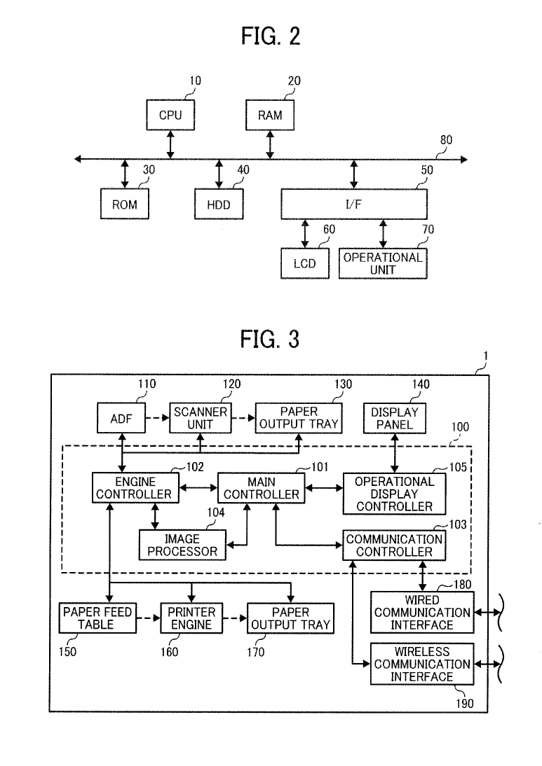

FIG. 2 is a block diagram illustrating a hardware configuration of the image processing apparatus 1. As shown in FIG. 2, the mobile information processing apparatus 2 in this embodiment has the same configuration as a general server or PC, etc.

That is, in the mobile information processing apparatus 2 in this embodiment, a Central Processing Unit (CPU) 10, a Random Access Memory (RAM) 20, a Read Only Memory (ROM) 30, a hard disk drive (HDD) 40, and an interface (I/F) 50 are connected with each other via a bus 80. In addition, a Liquid Crystal Display (LCD) 60 and an operational unit 70 are connected to the I/F 50. The image processing apparatus 1 includes an engine that executes forming an image, outputting the image, and scanning.

The CPU 10 is a processor and controls the whole operation of the mobile information processing apparatus 2. The RAM 20 is a volatile storage device that can read/write information at high speed and is used as a work area when the CPU 10 processes information. The ROM 30 is a read-only nonvolatile storage device and stores programs such as firmware. The HDD 40 is a nonvolatile storage device that can read/write information and stores the OS, various control programs, and application programs etc. In addition to the HDD, semiconductor memory devices such as a Solid State Drive (SSD) can be used.

The I/F 50 connects the bus 80 with various hardware and network, etc., and controls them. The LCD 60 is a visual user interface to check status of the information processing apparatus. The operational unit 70 is a user interface such as a keyboard, mouse, various hardware buttons, and touch panel to input information to the mobile information processing apparatus 2. It should be noted that the mobile device 2 functions as the control panel of the image processing apparatus 1 in the system of this embodiment. Consequently, the user interfaces connected to the image processing apparatus 1 directly such as the LCD 60 and the operational unit 70 can be omitted.

In the hardware configuration described above, programs stored in storage devices such as the ROM 30, HDD 40, and optical discs (not shown in figures) are read to the RAM 20, and a software control unit is implemented by executing operation in accordance with the programs by the CPU 10. Functional blocks that implement functions of apparatuses that consist of the image processing system of this embodiment are implemented by a combination of the software control units described above and hardware.

Next, functions of the image processing apparatus 1 in this embodiment are described below. FIG. 3 is a block diagram illustrating a functional configuration of the image processing apparatus 1. As shown in FIG. 3, the image processing apparatus 1 includes a controller 100, an Auto Document Feeder (ADF) 110, a scanner unit 120, a paper output tray 130, a display panel 140, a paper feed table 150, a print engine 160, a paper output tray 170, a wired communication interface (I/F) 180, and a wireless communication OF 190.

The controller 100 includes a main controller 101, an engine controller 102, an input/output controller 103, an image processor 104, and an operational display controller 105. As shown in FIG. 3, the image processing apparatus 1 in this embodiment is constructed as the MFP that includes the scanner unit 120 and the print engine 160. In FIG. 3, solid arrows indicate electrical connections, and dashed arrows indicate flow of paper.

The display panel 140 is both an output interface that displays status of the image processing apparatus 1 visually and an input interface (operational unit) to operate the image processing apparatus 1 directly or input information to the image processing apparatus 1. While the display panel 140 is realized by the LCD 60 and the operational unit 70 shown in FIG. 2, it is possible to configure only the mobile device 2 as the user interface of the image processing apparatus 1 and omit the display panel 140.

The wired communication I/F 180 is an interface that the image processing apparatus 1 communicates with other apparatuses by wired communication, and Ethernet and USB interface are used for the wired communication IT 180. The wireless communication I/F 190 is an interface that the image processing apparatus 1 communicates with other apparatuses by wireless communication, and interfaces such as Wireless Fidelity (Wi-Fi) and FeliCa are used as the wireless communication I/F 190. The image processing apparatus 1 exchanges information with the mobile device 2 using the wired communication I/F 180 or the wireless communication I/F 190.

The controller 100 combines software and hardware. In particular, control programs such as firmware stored in nonvolatile storage devices such as the ROM 30 and the HDD 40 are loaded into the RAM 20, and the software control unit is implemented by executing operations by the CPU 10 in accordance with the programs. The controller 100 is implemented by the software control unit and hardware such as integrated circuits. The controller 100 functions as a controller that exerts overall control of the image processing apparatus 1.

The main controller 101 controls each unit included in the controller 100 and sends commands to each unit in the controller 100. The engine controller 102 controls and drives the print engine 160 and the scanner unit 120. The input/output controller 103 inputs signals and commands input via the wired communication I/F 180 and the wireless communication I/F 190 to the main controller 101. In addition, the main controller 101 controls the input/output controller 103 and accesses other apparatuses such as the mobile device 2 via the wired communication I/F 180 and the wireless communication I/F 190.

The image processor 104 generates drawing information based on image information to be printed and output under the control of the main controller 101. The drawing information is information that the print engine 160 as an image forming unit draws as an image to be formed in an image forming operation. The image processor 104 processes image pickup data input front the scanner unit 120 and generates image data. The generated image data is stored in the image processing apparatus 1 as a result of the scanner operation or transferred to another apparatus via the wired communication I/F 180 and the wireless communication I/F 190. The operational display controller 105 displays information on the display panel 140 and reports information input via the display panel to the main controller 101.

In the case of image processing apparatus that only has the printer function, the ADF 110, the scanner unit 120, and the paper output tray 130 shown in FIG. 3 are omitted, and functions to control the ADF 110, the scanner unit 120, and the paper output tray 130 are omitted from functions included in the engine controller 102.

If the image processing apparatus 1 functions as the printer, first, the input output controller 103 receives a print job via the wired communication I/F 180 and the wireless communication I/F 190. The received print job was generated by the information processing apparatus that requests the image processing apparatus 1 to execute printing. In addition, the print job includes header information to indicate that it is the print job, image information to be output, and parameter information to be configured to execute printing.

The input/output controller 103 transfers the received print job to the main controller 101. After receiving the print job, the main controller 101 generates the drawing information based on the document information and image information included in the print job by controlling the image generator 104. After the image generator 104 generates the drawing information, the engine controller 102 executes forming an image on paper carried from the paper feed table 150 based on the generated drawing information. As particular examples of the print engine 160, image forming mechanisms such as inkjet method and electrophotography method can be used. After the print engine 160 forms the image on the paper, the paper is ejected on the paper output tray 170.

If the image processing apparatus 1 functions as a scanner, in response to a command to execute scanning input by operation on the display panel 140 or from an external apparatus via the wired communication I/F 180 and the wireless communication I/F 190, the operational display controller 105 or the input/output controller 103 transfers a signal to execute scanning to the main controller 101. The main controller 101 controls the engine controller 102 based on the received signal to execute scanning. The engine controller 102 drives the ADF 110 and carries a document to be scanned set on the ADF 110 to the scanner unit 120. In addition, the engine controller 102 drives the scanner unit 120 and scans the document carried from the ADF 110. If the document is not set on the ADF 110 and the document is set on the scanner unit 120 directly, the scanner unit 120 scans the set document under the control of the engine controller 102. That is, the scanner unit 120 functions as the image pickup unit.

In a scanning operation, an image pickup device such as CCD included in the scanner unit 120 scans the document optically, and image pickup information is generated based on the optical information. The engine controller 102 transfers the image pickup information generated by the scanner unit 120 to the image processor 104. The image processor 104 generates the image information based on the image pickup information received from the engine controller 102 under the control of the main controller 101. The image information generated by the image processor 104 is stored in the storage device such as the HDD 40 attached to the image processing apparatus 1. The image information generated by the image processor 104 is either stored in the HDD 40 etc. as is or transferred to an external apparatus by the input/output controller 103 via the wired communication I/F 180 or the wireless communication I/F 190 depending on the user instruction.

If the image processing apparatus 1 functions as a copier, the image processor 104 generates the drawing information based on either the image pickup information received from the scanner unit 120 by the engine controller 102 or the image information generated by the image processor 104. Similarly as the printer operation, the engine controller 102 drives the print engine 160 based on the drawing information.

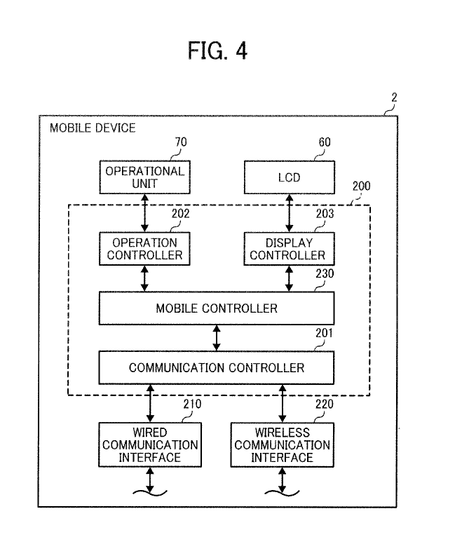

Next, a functional configuration of the mobile device 2 in this embodiment is described below with reference to FIG. 4. As shown in FIG. 4, the mobile device 2 in this embodiment includes a controller 200, a wired communication I/F 210, and a wireless Communication I/F 220 in addition to the LCD 60 and the operational unit 70 shown in FIG. 2. The controller 200 includes an input/output controller 201, an operation controller 202, a display controller 203, and a mobile controller 230.

The wired communication I/F 210 is an interface that the mobile device 2 communicates with other apparatuses via a network, and Ethernet and USB interface are used for the wired communication I/F 210. The wireless communication I/F 220 is an interface that the mobile device 2 communicates with other apparatuses by wireless communication, and interfaces such as Bluetooth, Wi-Fi, and FeliCa are used as the wireless communication I/F 220. The wired communication CF 210 and the wireless communication I/F 220 can be realized by the I/F 50 shown in FIG. 2.

The controller 200 is implemented by a combination of software and hardware. The controller 200 exerts overall control of the mobile device 2. The input/output controller 201 acquires information input via the wired communication I/F 210 and transfers information to other apparatuses via the wired communication 210. In addition, the input/output controller 201 acquires information input via the wireless communication I/F 220 and transfers information to other apparatuses via the wireless communication I/F 220.

The operation controller 202 acquires a signal of user operation on the operational unit 70 and input the signal to a module that operates on the mobile device 2 such as the mobile controller 230. The display controller 203 displays status of the mobile device 2 such as graphical user interface (GUI) of the mobile controller 230 on the LCD 60 as a display unit of the mobile device 2.

The mobile controller 230 exerts overall control of the mobile device 2 by sending commands to each unit by the controller 200. The mobile controller 230 is implemented as the OS, middleware, and various applications. A function to control switching between the standard screen and the simple screen displayed on the mobile device 2 among functions included in the mobile controller 230 is the key point in this embodiment.

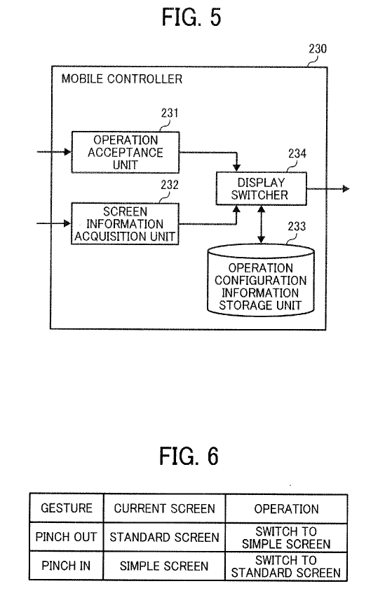

Next, the function to control switching between the standard screen and the simple screen displayed on the mobile device 2 among functions included in the mobile controller 230 is described below with reference to FIG. 5.

As shown in FIG. 5, the mobile controller 230 in this embodiment includes an operation acceptance unit 231, a screen information acquisition unit 232, an operation configuration information storage unit 233, and a display switcher 234.

After accepting a signal containing the content of an operation input from the operation controller 202, the operation acceptance unit 231 outputs the signal to the display switcher 234. The screen information acquisition unit 232 acquires screen information (i.e., standard screen or simple screen) displayed on the LCD 60 currently and outputs the screen information to the display switcher 234.

FIG. 6 is a diagram illustrating operation configuration information stored in the operation configuration information storage unit 233. The operation configuration information indicates content of an operation if a predetermined gesture is performed on the standard screen or the simple screen that can be displayed on the mobile device 2. For example, as shown in FIG. 6, if a pinch-out operation is performed on the standard screen (current screen) displayed on the mobile device 2, it is configured to switch to the simple screen.

The pinch-out operation means an operation in which a position (coordinate) is specified by touching two points on the screen with two fingers and the fingers are spread apart. This operation is used for enlarging the screen for example. Since the screen expands along with the operation that increases the distance between the touched positions, that can be an intuitive operation.

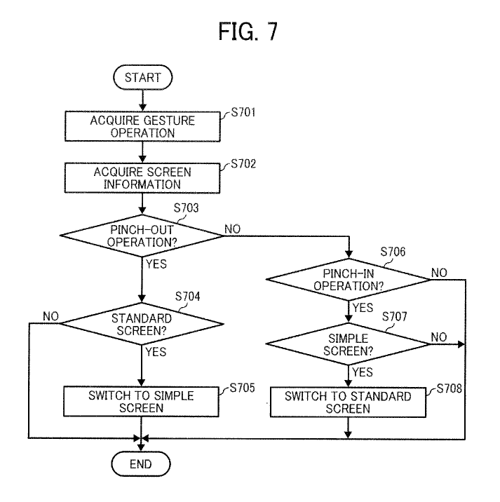

After referring to the operation configuration information stored in the operation configuration information storage unit 233, the display switcher 234 specifies content of the operation in accordance with the signal containing content of the operation input from the operation acceptance unit 231 and the screen information input from the screen information acquisition unit 232. In addition, the display switcher 234 switches the screen displayed on the mobile device 2 by instructing the display controller 203 to control the LCD 60 in accordance with the specified content of the operation. That operation is described in detail later with reference to FIG. 7.

In addition, the display switcher 234 displays content of settings configured on the screen before switching, inheriting them as is after switching the screen. In case of switching from the standard screen to the simple screen, the display switcher 234 instructs the communication controller 201 to send a command of initializing settings to the image processing apparatus 1 via the wired communication I/F 210 or the wireless communication I/F 220 to initialize settings not displayed on the simple screen.

Next, a process performed by the display switcher 234 based on the operation configuration information shown in FIG. 6 is described below. FIG. 7 is a flowchart illustrating a process performed by the display switcher 234 based on the operation configuration information shown in FIG. 6. In S701, the display switcher 234 acquires a signal containing content of the operation from the operation acceptance unit 231. In S702, the display switcher 234 acquires screen information from the screen information acquisition unit 232.

In S703, the display switcher 234 determines whether or not the gesture acquired in S701 is the pinch-out operation. If the display switcher 234 determines that the gesture is the pinch-out operation, the process proceeds to S704. If the display switcher 234 determines that the gesture is not the pinch-out operation, the process proceeds to S706.

In S704, the display switcher 234 determines whether or not the screen information acquired in S702 indicates the standard screen. If the display switcher determines that the screen information indicates the standard screen, the process proceeds to S705. If the display switcher determines that the screen information does not indicate the standard screen, the process ends. In S705, the display switcher 234 switches the screen displayed on the mobile device 2 from the standard screen to the simple screen. That corresponds to switching to the simple screen in case of performing the pinch-out operation on the standard screen among the operation configuration information shown in FIG. 6.

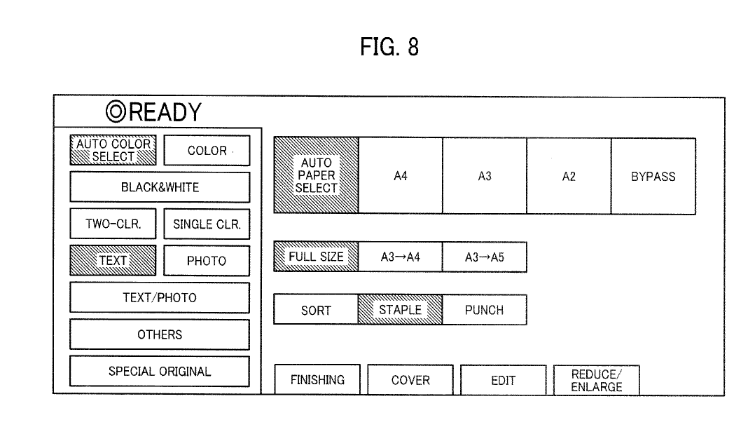

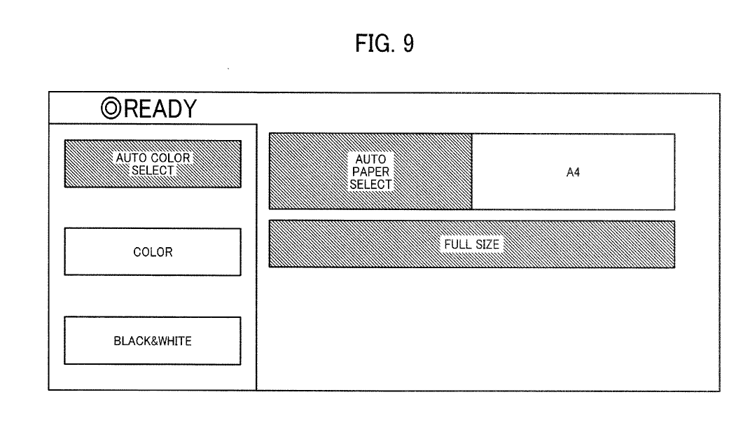

FIG. 8 is a diagram illustrating the standard screen that displays multiple setting items configured to perform copying on the image processing apparatus 1. As shown in FIG. 8, in this example, setting items displayed with hatched lines (e.g., “Auto Color Select” and “Text” etc.) are selected to perform copying. FIG. 9 is a diagram illustrating the simple screen that displays some of the setting items displayed on the standard screen.

For example, in S705, the display switcher 234 instructs the display controller 203 to control the LCD 60 and switch the screen displayed on the mobile device 2 from the standard screen shown in FIG. 8 to the simple screen shown in FIG. 9. In addition, in case of switching the displayed screen from the standard screen to the simple screen, setting items also displayed on the simple screen such as “Auto Color Select”, “Auto Paper Select”, and “Full Size” are displayed as selected, and setting items not displayed on the simple screen such as “Text” and “Staple” are initialized. (For example, “Staple” is reset to a state that “Sort” is selected.)

In S706, the display switcher 234 determines whether or not the gesture acquired in S701 is a pinch-in operation. If the display switcher 234 determines that the gesture is the pinch-in operation, the process proceeds to S707. If the display switcher 234 determines that the gesture is not the pinch-in operation, the process ends since the gesture is not defined in the operation configuration information shown in FIG. 6.

The pinch-in operation means an operation in which a position (coordinate) is specified by touching two points on the screen with two fingers and the fingers are moved closer together. This operation is used for reducing the screen for example. Since the screen reduces along with the operation that decreases the distance between the touched positions, that can be an intuitive operation.

In S707, the display switcher 234 determines whether or not the screen information acquired in S702 indicates the simple screen. If the display switcher determines that the screen information indicates the simple screen, the process proceeds to S708. If the display switcher determines that the screen information does not indicate the simple screen, the process ends. In S708, the display switcher 234 switches the screen displayed on the mobile device 2 from the simple screen to the standard screen. That corresponds to switching to the standard screen in case of performing the pinch-in operation on the simple screen among the operation configuration information shown in FIG. 6.

For example, in S708, the display switcher 234 instructs the display controller 203 to control the LCD 60 and switch the screen displayed on the mobile device 2 from the simple screen shown in FIG. 9 to the standard screen shown in FIG. 8.

As described above, switching between the standard screen and the simple screen can be realized in this embodiment. In this embodiment, the pinch-out/pinch-in operation generally used for enlarging/reducing the screen size switches between the standard screen and the simple screen. In other words, the operation for enlarging/reducing the screen switches from displaying broader range to displaying in detail and vice versa. By applying such operations to switching between the standard screen and the simple screen, it is possible to realize intuitive operations.

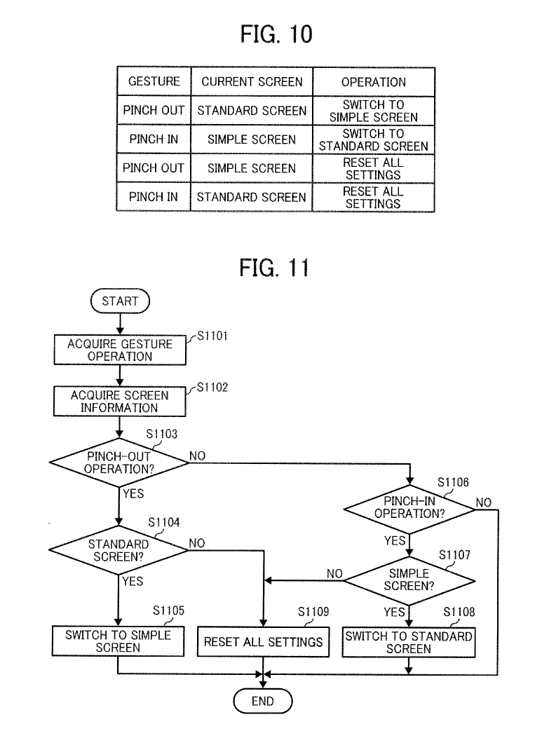

In the embodiment described above, the operation configuration information includes the switching operation that switches between the standard screen and the simple screen by the predefined gestures. However, the operation configuration information can include other operation contents in accordance with gestures. FIG. 10 is a diagram illustrating operation configuration information that includes an operation content that resets the configured setting items in case of performing predefined gestures are performed on the standard screen and the simple screen.

For example, as shown in FIG. 10, it is configured to reset all setting items configured on the simple screen in case of performing, the pinch-out operation on the simple screen (current screen) displayed on the mobile device 2.

Next, a process performed by the display switcher 234 based on the operation configuration information shown in FIG. 10 is described below. FIG. 11 is a flowchart illustrating a process performed by the display switcher 234 based on the operation configuration information shown in FIG. 10. In S1101, the display switcher 234 performs the same as in S701 in FIG. 7, and in S1102, the display switcher 234 performs the same as in S702 in FIG. 7.

In S1103, the display switcher 234 determines whether or not the gesture acquired in S1101 is the pinch-out operation. If the display switcher 234 determines that the gesture is the pinch-out operation, the process proceeds to S1104. If the display switcher 234 determines that the gesture is not the pinch-out operation, the process proceeds to S1106.

In S1104, the display switcher 234 determines whether or not the screen information acquired in S1102 indicates the standard screen. If the display switcher determines that the screen information indicates the standard screen, the process proceeds to S1105. If the display switcher determines that the screen information does not indicate the standard screen the screen information indicates the simple screen), the process proceeds to S1109.

In S1105, the display switcher 234 switches the screen displayed on the mobile device 2 from the standard screen to the simple screen. That corresponds to switching to the simple screen in case of performing the pinch-out operation on the standard screen among the operation configuration information shown in FIG. 10.

In S1106, the display switcher 234 determines whether or not the gesture acquired in S1101 is a pinch-in operation. If the display switcher 234 determines that the gesture is the pinch-in operation, the process proceeds to S1107. If the display switcher 234 determines that the gesture is not the pinch-in operation, the process ends since the gesture is not defined in the operation configuration information shown in FIG. 10.

In S1107, the display switcher 234 determines whether or not the screen information acquired in S1102 indicates the simple screen. If the display switcher determines that the screen information indicates the simple screen, the process proceeds to S1108. If the display switcher determines that the screen information does not indicate the simple screen (i.e., the screen information indicates the standard screen), the process proceeds to S1109.

In S1108, the display switcher 234 switches the screen displayed on the mobile device 2 from the simple screen to the standard screen. That corresponds to switching to the standard screen in case of performing the pinch-in operation on the simple screen among the operation configuration information shown in FIG. 10.

In S1109, the display switcher 234 resets all setting items configured on the standard screen or the simple screen. That corresponds to resetting all configured setting items in case 313 of performing the pinch-out operation on the simple screen or performing the pinch-in operation on the standard screen among the operation configuration information shown in FIG. 10.

For example, in S1109, the display switcher 234 instructs the communication controller 201 to send a command of resetting all setting items to the image processing apparatus 1 via the wired communication IT 210 or the wireless communication I/F 220.

As described above, in the state of displaying the standard screen or the simple screen already, the setting items are reset if the operation for switching to the screen currently displayed is performed. That is, the setting items are initialized to the default state after switching to the current screen as the response to the operation for switching to the screen currently displayed again, thereby providing intuitive operations.

In the embodiments described above, while gestures such as the pinch-out operation and the pinch-in operation are taken as examples, gestures are not limited to them. For example, various gestures such as a drag operation that draws an L-shaped pattern on the screen and a drag operation that draws a circle on the screen can be used as predefined operations for switching between the standard screen and the simple screen.

In addition, in the embodiments described above, although switching between the standard screen and the simple screen is performed based on the gestures, switching is not limited to just gestures. Here, the gestures mean operations that trace a predetermined path anywhere on the screen, and not only a single-touch path but also a multi-touch path can be used for that purpose. Since these operations are not used as operations on a normal screen, they are used as operations for inputting special commands.

By contrast, operations not usually used and distinguishable from other operations can be used for switching between the standard screen and the simple screen as a predetermined operation even if they are not gestures that trace a predetermined path. For example, tapping one point is often used for pushing a button, etc. However, tapping two points or three points at the same time is seldom used for pushing a button.

Consequently, a simple tapping operation on multiple points can be used for switching between the standard screen and the simple screen as a predetermined operation. Alternatively, an example of special touch operations other than the gesture can be an operation in which contact is maintained with one point while a second point is tapped.

In the embodiment described above, the information processing device is the mobile device 2 controlled independently from the image processing apparatus 1. However, the information processing device can be an operational unit that accepts gestures and is included in the image processing apparatus 1 such as a touch panel.

Numerous additional modifications and variations are possible in light of the above teachings. It is therefore to be understood that, within the scope of the appended claims, the disclosure of this patent specification may be practiced otherwise than as specifically described herein.

As can be appreciated by those skilled in the computer arts, this invention may be implemented as convenient using a conventional general-purpose digital computer programmed according to the teachings of the present specification. Appropriate software coding can readily be prepared by skilled programmers based on the teachings of the present disclosure, as will be apparent to those skilled in the software arts. The present invention may also be implemented by the preparation of application-specific integrated circuits or by interconnecting an appropriate network of conventional component circuits, as will be readily apparent to those skilled in the relevant art.

Each of the functions of the described embodiments may be implemented by one or more processing circuits. A processing circuit includes a programmed processor, as a processor includes circuitry. A processing circuit also includes devices such as an application specific integrated circuit (ASIC) and conventional circuit components arranged to perform the recited functions.

What is claimed is:

1. An image processing system comprising:
an image processing apparatus; and
an information processing device, that is separate from the image processing apparatus and which controls operation of the image processing apparatus,
wherein the information processing device includes:
a display configured to display one of a standard screen that displays multiple setting items to be configured in operating the image processing apparatus and a simple screen that displays some of the multiple setting items displayed on the standard screen:
an operational acceptance unit to accept an operation performed on a screen displayed on the display of the information processing device; and
a display switcher configured to switch display on the display of the information processing device between the standard screen and the simple screen when the operation accepted by the operational acceptance unit indicates a predetermined operation regardless of coordinates of the operation performed on the screen.

2. The image processing system according to claim 1, wherein the display switcher switches between the standard screen and the simple screen in accordance with the operation performed on the screen based on information that associates the predetermined operation with an operation for switching either to the standard screen or to the simple screen.

3. The image processing system according to claim 1, wherein the display switcher initializes the setting items included in the screen displayed on the display unit if the operation acceptance unit accepts an operation for switching either to the standard screen or to the simple screen currently displayed on the display.

4. The image processing system according to claim 1, wherein the predetermined operation is one of an operation moving two points specified on the screen farther apart and moving two points specified on the screen closer together.

5. A method of using an information processing device to control operation of an image processing apparatus, comprising the steps of:
displaying one of a standard screen that displays multiple setting items to be configured in operating the image processing apparatus and a simple screen that displays some of the multiple setting items displayed on the standard screen on a display of the information processing device;
accepting an operation on a screen displayed on the display; and
switching between the standard screen and the simple screen when the operation accepted by the accepting indicates a predetermined operation regardless of coordinates of the operation performed on the screen.

6. A computer-readable, non-transitory recording medium storing a program that, when executed by a computer, causes a processor to implement a method of using an information processing device to control operation of an image processing apparatus,
the control method comprising the steps of:
displaying one of a standard screen that displays multiple setting items to be configured in operating the image processing apparatus and a simple screen that displays some of the multiple setting items displayed on the standard screen on a display of the information processing device;
accepting an operation on a screen displayed on the display; and
switching between the standard screen and the simple screen when the operation accepted by the accepting indicates a predetermined operation regardless of coordinates of the operation performed on the screen.
